(19) United States
(12) Patent Application Publication
(10) Pub. No.: US 2019/0096405 A1
(43) Pub. Date: Mar. 28, 2019

(54) INTERACTION APPARATUS, INTERACTION METHOD, AND SERVER DEVICE

(71) Applicant: CASIO COMPUTER CO., LTD, Tokyo (JP)

(72) Inventor: Yoshihiro Kawamura, Tokyo (JP)

(21) Appl. No.: 16/142,585

(22) Filed: Sep. 26, 2018

(30) Foreign Application Priority Data
Sep. 27, 2017 (JP) 2017-186013

(51) Int. Cl. G10L 15/22; G10L 15/30; G10L 15/18; G10L 15/02

(52) U.S. Cl. CPC G10L 15/22; G10L 15/02; G10L 15/1815; G10L 15/30

(57) ABSTRACT

An interaction apparatus includes a microphone, a speech recorder, a communicator, a response sentence information acquirer, and a responder. The microphone acquires speech uttered by a user as speech data. The speech recorder records speech information that is based on the speech data acquired by the microphone. The communicator communicates with an external server device. In a state in which communication via the communicator with the server device is restored after temporal communication disconnection, the response sentence information acquirer sends, to the server device, the speech information recorded by the speech recorder during communication disconnection, and acquires, from the server device, response sentence information for the speech information. The responder responds to the user with a response sentence created on the basis of the response sentence information acquired by the response sentence information acquirer.

### CROSS-REFERENCE TO RELATED APPLICATION

This application claims the benefit of Japanese Patent Application No. 2017-186013, filed on Sep. 27, 2017, the entire disclosure of which is incorporated by reference herein.

### FIELD

This application relates generally to technology for a robot or the like to interact with a user through speech.

### BACKGROUND

In the related art, advances have been made in the development of terminals and robots capable of interacting with users. Moreover, advances have been made in the development of a system in which an external server performs various processing when such a terminal or robot interacts with a user. Examples of the various processing include high-load processing such as speech recognition processing and language comprehension processing, and processing for searching for information that is not stored in the storage means of the robot. For example, Unexamined Japanese Patent Application Kokai Publication No. 2003-111981 describes a robot device that network connects to an external server in response to an interaction with a user, dynamically acquires necessary data and/or programs, and uses these data and/or programs in communication with the user.

### SUMMARY

To achieve the above objective, an interaction apparatus of the present disclosure includes a memory, a communicator, and a controller, and is configured to create a response sentence for speech uttered by a user through communication with an external server device. The controller is configured to acquire the speech uttered by the user as speech data, record, in the memory, speech information that is based on the acquired speech data, and communicate with a server device via the communicator. The controller is further configured to, in a state in which communication with the server device is restored after temporal communication disconnection, send the speech information recorded during the communication disconnection to the server device, and acquire, from the server device, response sentence information for the speech information. The controller is further configured to respond to the user with a response sentence created on the basis of the acquired response sentence information. The response sentence is created on the basis of a feature word included in text data that are acquired by performing speech recognition on the speech data.

### BRIEF DESCRIPTION OF THE DRAWINGS

A more complete understanding of this application can be obtained when the following detailed description is considered in conjunction with the following drawings, in which:

FIG. 1 is a drawing illustrating the configuration of an interaction system according to Embodiment 1 of the present disclosure;

FIG. 2 is a drawing illustrating the appearance of an interaction apparatus according to Embodiment 1;

FIG. 3 is a diagram illustrating the configuration of the interaction apparatus according to Embodiment 1;

FIG. 4 is a table illustrating an example of additional information-appended speech information that the interaction apparatus according to Embodiment 1 stores;

FIG. 5 is a diagram illustrating the configuration of a server device according to Embodiment 1;

FIG. 6 is a table illustrating an example of response sentence creation rules that the server device according to Embodiment 1 stores;

FIG. 7 is a flowchart of interaction control processing of the interaction apparatus according to Embodiment 1;

FIG. 8 is a flowchart of an appearance thread of the interaction apparatus according to Embodiment 1;

FIG. 9 is a flowchart of response sentence creation processing of the server device according to Embodiment 1;

FIG. 10 is a diagram illustrating the configuration of an interaction apparatus according to Embodiment 2;

FIG. 11 is a table illustrating an example of a response sentence information list that the interaction apparatus according to Embodiment 2 stores;

FIG. 12 is a flowchart of interaction control processing of the interaction apparatus according to Embodiment 2;

FIG. 13 is a flowchart of response sentence creation processing of the server device according to Embodiment 2;

FIG. 14 is a diagram illustrating the configuration of an interaction apparatus according to Embodiment 3;

FIG. 15 is a table illustrating an example of position history data that the interaction apparatus according to Embodiment 3 stores;

FIG. 16 is a flowchart of interaction control processing of the interaction apparatus according to Embodiment 3;

FIG. 17 is a table illustrating examples of feature words, response sentences, and location names that the server device according to Embodiment 3 sends to the interaction apparatus; and

FIG. 18 is a flowchart of response sentence creation processing of the server device according to Embodiment 3.

### DETAILED DESCRIPTION

Hereinafter, embodiments of the present disclosure are described while referencing the drawings and tables. Note that, in the drawings, identical or corresponding components are marked with the same reference numerals.

### Embodiment 1

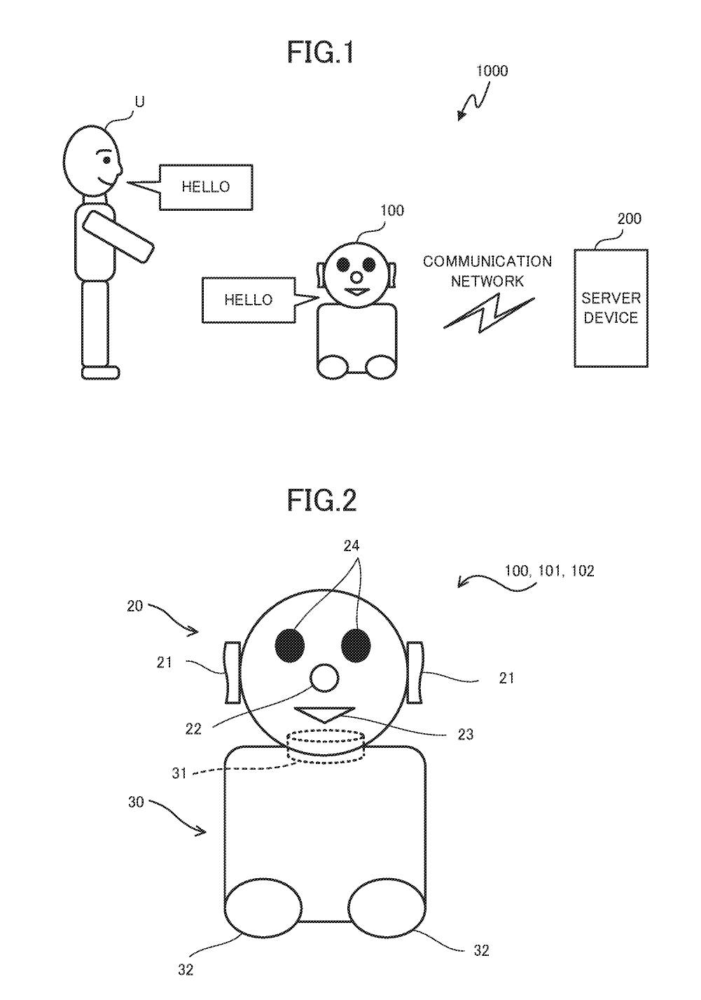

As illustrated in FIG. 1, an interaction system 1000 according to Embodiment 1 of the present disclosure includes an interaction apparatus 100, namely a robot, which interacts with a user U through speech, and a server device 200 that performs various types of processing (for example, speech recognition processing, response sentence creation processing, and the like) required when the interaction apparatus 100 interacts with the user U. The interaction apparatus 100 sends data of speech (speech data) uttered by the user U to the external server device 200, and the speech recognition processing, the response sentence information creation, and the like are performed by the server device 200. As a result, the processing load of the interaction apparatus 100 when interacting with the user U is reduced.

As illustrated in FIG. 2, the interaction apparatus 100 includes a head 20 and a body 30. A microphone 21, a camera 22, a speaker 23, and a sensor group 24 are provided in the head 20 of the interaction apparatus 100.

The microphone 21 is provided in plurality on the left side and the right side of the head 20, at positions corresponding to the ears of the face of a human. The plurality of microphones 21 forms a microphone array. The microphones 21 function as a speech acquirer that acquires, as the speech data, the speech uttered by the user U near the interaction apparatus 100.

The camera 22 is an imaging device and is provided in the center of the front side of the head 20, at a position corresponding to the nose of the face of a human. The camera 22 functions as an image acquirer that acquires data of images (image data) in front of the interaction apparatus 100, and inputs the acquired image data into a controller 110 (described later).

The speaker 23 is provided below the camera 22, at a position corresponding to the mouth of the face of a human. The speaker 23 functions as a speech outputter that outputs speech.

The sensor group 24 is provided at positions corresponding to the eyes of the face of a human. The sensor group 24 includes an acceleration sensor, an obstacle detection sensor, and the like, and detects a variety of physical quantities. The sensor group 24 is used for posture control, collision avoidance, safety assurance, and the like of the interaction apparatus 100.

As illustrated in FIG. 2, the head 20 and the body 30 of the interaction apparatus 100 are coupled to each other by a neck joint 31, which is indicated by the dashed lines. The neck joint 31 includes a plurality of motors. The controller 110 (described later) can cause the head 20 of the interaction apparatus 100 to rotate on three axes, namely an up-down direction, a left-right direction, and a tilt direction, by driving the plurality of motors. As a result, the interaction apparatus 100 can exhibit nodding behavior, for example.

As illustrated in FIG. 2, an undercarriage 32 are provided on the lower portion of the body 30 of the interaction apparatus 100. The undercarriage 32 include four wheels and a driving motor. Of the four wheels, two wheels are disposed on the front side of the body 30 as front wheels, and the remaining two wheels are disposed on the back side of the body 30 as rear wheels. Examples of the wheels include Omni wheels, Mecanum wheels, and the like. The interaction apparatus 100 moves when the controller 110 (described later) controls the driving motor to rotate the wheels.

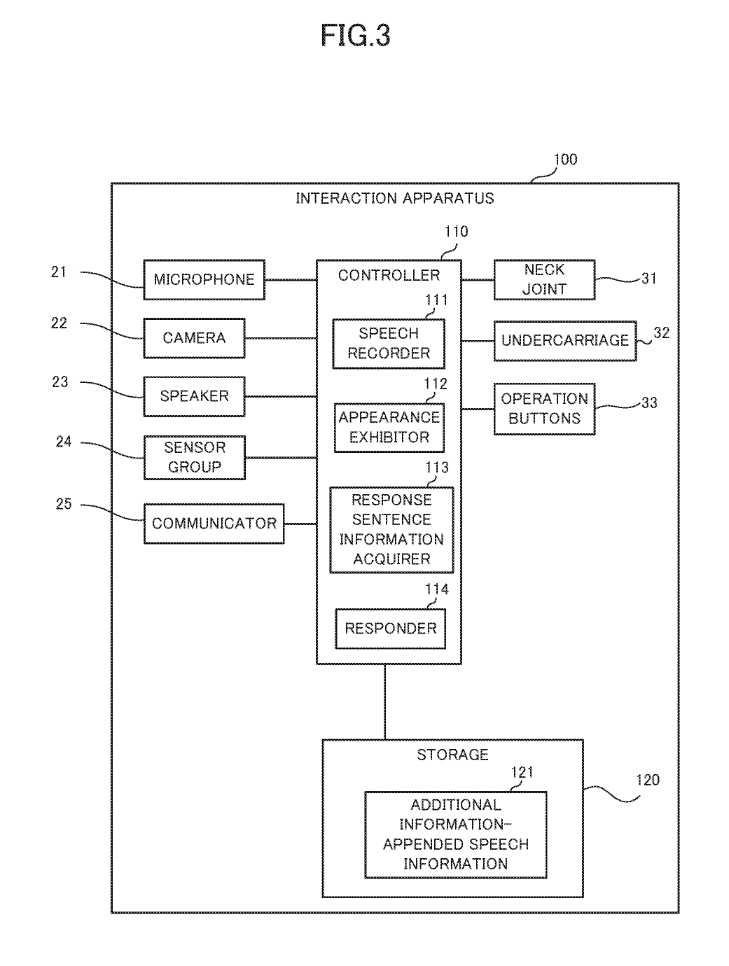

Next, the functional configuration of the interaction apparatus 100 is described while referencing FIG. 3. As illustrated in FIG. 3, the interaction apparatus 100 includes the configuration described above and, in addition, includes a communicator 25, operation buttons 33, a controller 110, and a storage 120.

The communicator 25 is for wirelessly communicating with external devices such as the server device 200, and is a wireless module that includes an antenna. In one example, the communicator 25 is a wireless module for wirelessly communicating across a wireless local area network (LAN). By using the communicator 25, the interaction apparatus 100 can send speech information such as the speech data to the server device 200, and can receive response sentence information (described later) from the server device 200. The wireless communication between the interaction apparatus 100 and the server device 200 may be direct communication or may be communication that is carried out via a base station, an access point, or the like.

While not illustrated in the drawings, the operation buttons 33 are provided at a position on the back of the body 30. The operation buttons 33 are various buttons for operating the interaction apparatus 100. The operation buttons 33 include a power button, a volume control button for the speaker 23, and the like.

The controller 110 is configured from a central processing unit (CPU), or the like. By executing programs stored in the storage 120, the controller 110 functions as a speech recorder 111, an appearance exhibitor 112, a response sentence information acquirer 113, and a responder 114 (all described later). Additionally, the controller 110 is provided with a clock function and a timer function, and can acquire the current time (current time and date), elapsed time, and the like.

The storage 120 is configured from read-only memory (ROM), random access memory (RAM), or the like, and stores the programs that are executed by the CPU of the controller 110, various types of data, and the like. Additionally, the storage 120 stores additional information-appended speech information 121, which is obtained by appending the speech data acquired by the speech acquirer (the microphone 21) with an utterance date and time or the like.

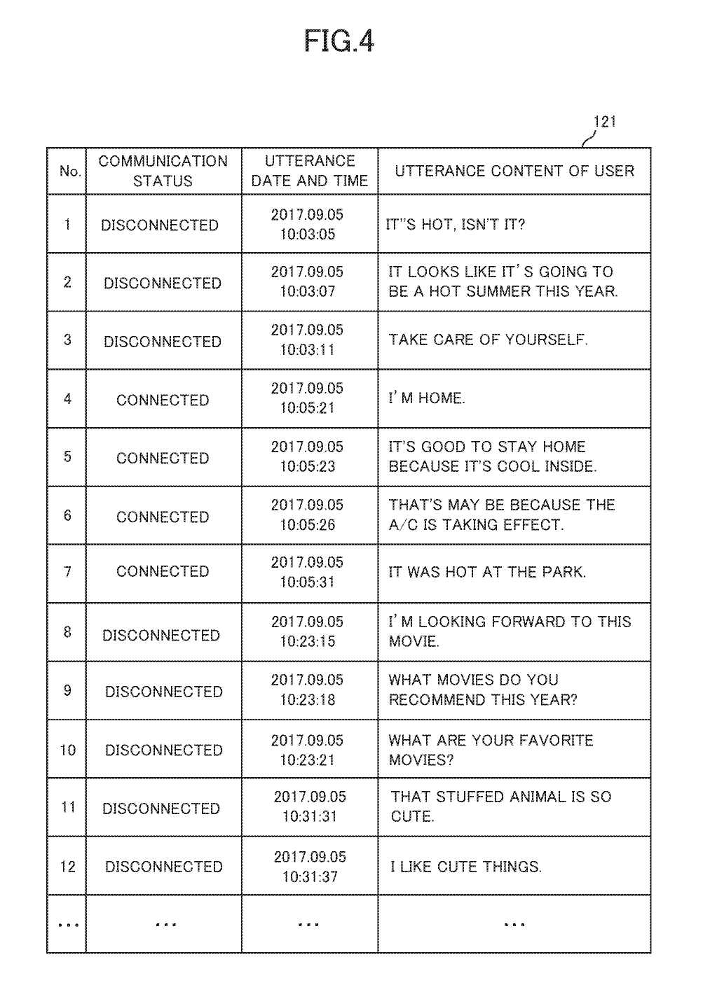

As illustrated in FIG. 4, the additional information-appended speech information 121 is data obtained by recording a communication status and an utterance date and time together with the content uttered by the user U. The value of the communication status is “connected” when the communicator 25 can communicate with the server device 200, and is “disconnected” when the communicator 25 cannot communicate with the server device 200. In FIG. 4, the additional information-appended speech information 121 is stored regardless of the communication status, but a configuration is possible in which only the additional information-appended speech information 121 from when the communication status is “disconnected” is stored in the storage 120. Additionally, a configuration is possible in which the detection of a communication disconnection triggers the start of the storage of the additional information-appended speech information 121. Moreover, a configuration is possible in which the value of the communication status is not included in the additional information-appended speech information 121, and the server device 200 determines the communication status on the basis of the utterance date and time.

Next, the various functions realized by the controller 110 are described. As described above, by executing the programs stored in the storage 120, the controller 110 functions as a speech recorder 111, an appearance exhibitor 112, a response sentence information acquirer 113, and a responder 114. Additionally, when the controller 110 is compatible with multithreading functionality, the controller 110 can execute a plurality of threads (different processing flows) in parallel.

The speech recorder 111 appends the speech data acquired by the speech acquirer (the microphone 21) with the utterance date and time or the like, and records this data as the additional information-appended speech information 121 in the storage 120. In the present embodiment, as described later, the speech recognition processing is performed by the server device 200, but an embodiment is possible in which the speech recognition processing is performed by the interaction apparatus 100. In such a case, the speech recorder 111 may record text data, obtained by performing speech recognition on the speech data, in the storage 120. Herein, the information that the interaction apparatus 100 sends to the server device 200 is referred to as “speech information.” In the present embodiment, the speech information is the speech data acquired by the speech acquirer, but an embodiment is possible in which the speech information is text data obtained by performing speech recognition on the speech information. Moreover, the additional information-appended speech information 121 is information obtained by appending the speech information with an utterance date and time or the like.

When communication with the server device 200 via the communicator 25 is disconnected, the appearance exhibitor 112 performs control for exhibiting behavior that appears to the user U as if the interaction device 100 is listening to content uttered by the user U. Specifically, the appearance exhibitor 112 controls the neck joint 31, the speaker 23, and the like to exhibit behavior such as nodding, giving responses, and the like.

The response sentence information acquirer 113 acquires, via the communicator 25, information related to a response sentence (response sentence information) created by the server device 200. The response sentence information is described later.

The responder 114 responds to the user U with the response sentence created on the basis of the response sentence information acquired by the response sentence information acquirer 113. Specifically, the responder 114 performs speech synthesis on the response sentence created on the basis of the response sentence information, and outputs speech of the response sentence from the speaker 23. Note that an embodiment is possible in which the speech synthesis processing is performed by the server device 200. In such an embodiment, voice data resulting from the speech synthesis is sent from the server device 200 as the response sentence information and, as such, the responder 114 can output the voice data without modification from the speaker 23 without the need for speech synthesis processing.

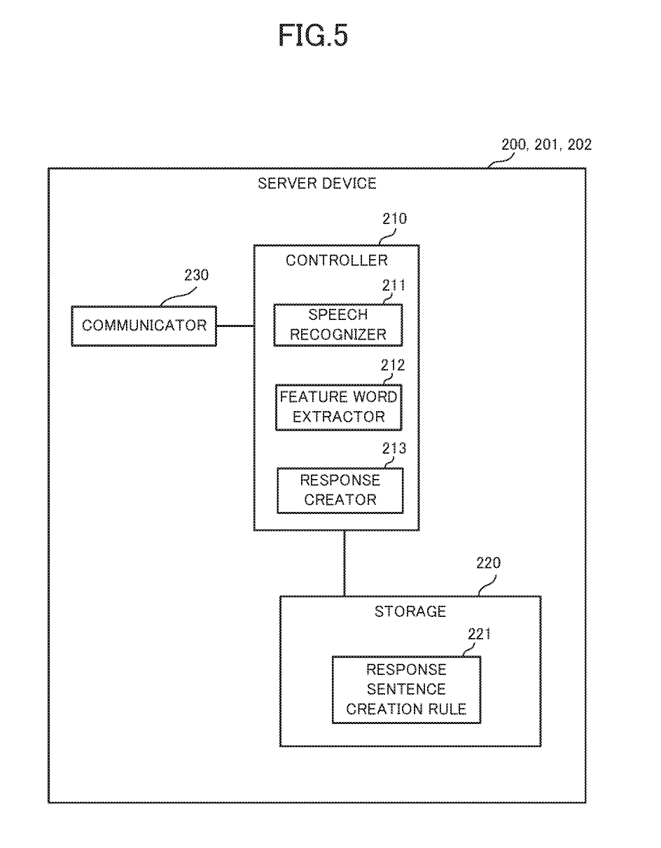

The functional configuration of the interaction apparatus 100 is described above. Next, the functional configuration of the server device 200 is described. As illustrated in FIG. 5, the server device 200 includes a controller 210, a storage 220, and a communicator 230.

The controller 210 is configured from a CPU or the like. By executing programs stored in the storage 220, the controller 210 functions as a speech recognizer 211, a feature word extractor 212, and a response creator 213 (all described later).

The storage 220 is configured from ROM, RAM, or the like, and stores the programs that are executed by the CPU of the controller 210, various types of data, and the like. Additionally, the storage 220 stores response sentence creation rules 221 (described later).

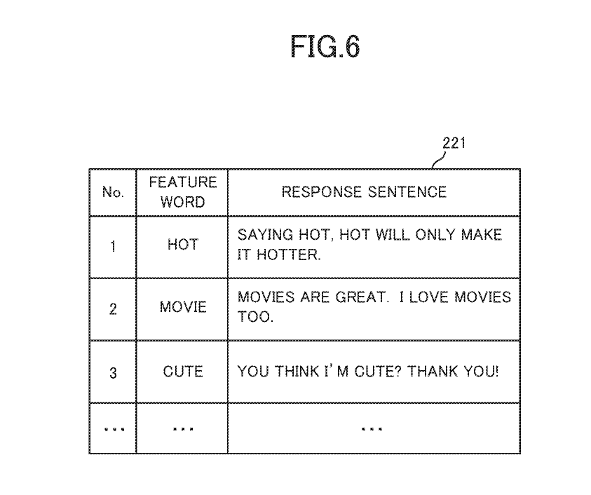

As illustrated in FIG. 6, the response sentence creation rules 221 are rules that associate response sentences with specific words (feature words). Note that, in FIG. 6, the response sentence creation rules 221 are depicted as rules in which specific words such as “hot”, “movie”, and “cute” are assigned as the feature words, but the response sentence creation rules 221 are not limited thereto. For example, “negative adjective expressing hot or cold: X” may be defined as a feature word and a rule may be provided for associating this feature word with the response sentence, “Saying X, X will only make it Xer.” Other examples of response sentence creation rules for adjectives expressing hot or cold include, for example, a rule in which “positive adjective expressing hot or cold: Y” is defined as the feature word and the response sentence for this feature word is “It's gotten Y lately. When it is Y, it is nice.” Here, examples of the negative adjectives expressing hot or cold include “hot” and “cold”, and examples of the positive adjectives expressing hot or cold include “cool” and “warm.”

The communicator 230 is a wireless module that includes an antenna, and is for wirelessly communicating with external devices such as the interaction apparatus 100. In one example, the communicator 230 is a wireless module for wirelessly communicating across a wireless local area network (LAN). By using the communicator 230, the server device 200 can receive speech information such as the speech data from the interaction apparatus 100, and can send response sentence information (described later) to the interaction apparatus 100. The controller 210 functions as a receiver when receiving the speech information from the interaction apparatus 100 via the communicator 230, and functions as a transmitter when sending the response sentence information to the interaction apparatus 100 via the communicator 230.

Next, the various functions realized by the controller 210 are described. As described above, by executing the programs stored in the storage 220, the controller 210 functions as a speech recognizer 211, a feature word extractor 212, and a response creator 213.

The speech recognizer 211 performs speech recognition on the speech data included in the additional information-appended speech information 121 sent from the interaction apparatus 100, and generates text data representing the utterance content of the user U. As described above, the speech recognizer 211 in not necessary in embodiments in which the speech recognition is performed by the interaction apparatus 100. In such a case, the text data resulting from the speech recognition is included in the additional information-appended speech information 121 sent from the interaction apparatus 100.

The feature word extractor 212 extracts, from the text data generated by the speech recognizer 211 (or from the text data included in the additional information-appended speech information 121), a characteristic word, namely a feature word included in the text data. The feature word is, for example, the most frequently occurring specific word among specific words (nouns, verbs, adjectives, adverbs) included in the text data. Additionally, the feature word may be a specific word among specific words included in the text data that are modified by an emphasis modifier (“very”, “really”, or the like).

The response creator 213 creates information related to a response sentence (response sentence information) based on response rules. The response rules are rules of applying the feature word extracted by the feature word extractor 212 to the response sentence creation rules 221 stored in the storage 220 to create the response sentence information. The response creator 213 may use other rules as the response rules. Note that, in the present embodiment, the response creator 213 creates a complete response sentence as response sentence information, but the response sentence information is not limited thereto. In interaction processing, there is a series of processing including performing speech recognition on the speech uttered by the user U, parsing or the like, creating the response sentence, and performing speech synthesis. However, a configuration is possible in which a portion of this series of processing is performed by the server device 200 and the remaining processing is performed by the interaction apparatus 100. For example, a configuration is possible in which heavy processing such as the speech recognition, the parsing, and the like is performed by the server device 200, and processing for completing the response sentence is performed by the interaction apparatus 100. The assignments of the various processing to each device can be determined as desired. Thus, herein, the information that the server device 200 sends to the interaction apparatus 100 is referred to as “response sentence information,” and the information that the interaction apparatus 100 utters to the user U is referred to as a “response sentence.” In some cases, the response sentence information and the response sentence are the same (the content thereof is the same regardless of the signal form being different, such as being digital data or analog speech). In the present embodiment, the response sentence information and the response sentence are the same.

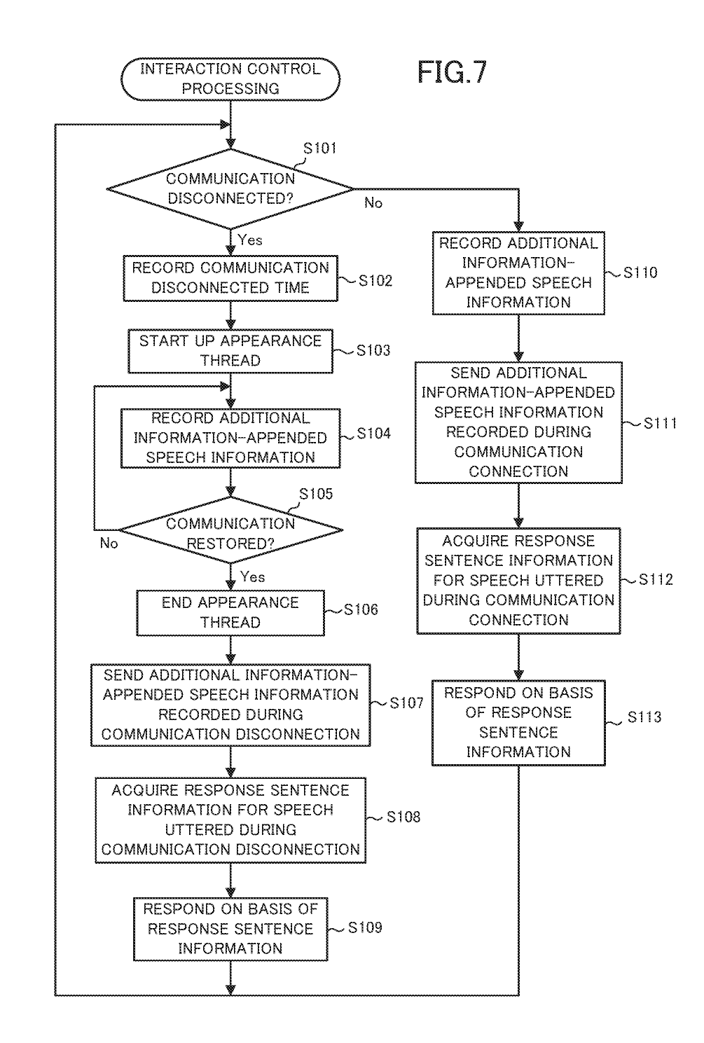

The functional configuration of the server device 200 is described above. Next, the interaction control processing performed by the controller 110 of the interaction apparatus 100 is described while referencing FIG. 7. This processing starts when the interaction apparatus 100 starts up and initial settings are completed.

First, the controller 110 determines whether communication with the server device 200 via the communicator 25 is disconnected (step S101). In one example, when the communicator 25 communicates with the server device 200 via an access point, communication with the server device 200 is determined to be disconnected if the communicator 25 cannot receive radio waves from the access point.

If communication with the server device 200 is disconnected (step S101; Yes), the controller 110 stores the current time (the time at which communication is disconnected) in the storage 120 (step S102). Then, the controller 110 as the appearance exhibitor 112 starts up an appearance thread (step S103) and performs the processing of the appearance thread (described later) in parallel.

Then, the controller 110 as the speech recorder 111 appends the speech data acquired by the speech acquirer (the microphone 21) with information of the connection status (disconnected) and information of the current time, and records this data as the additional information-appended speech information 121 in the storage 120 (step S104). Step S104 is also called a “speech recording step.” Thereafter, the controller 110 determines whether communication with the server device 200 has been restored (step S105). If communication with the server device 200 has not been restored (step S105; No), the controller 110 returns to step S104 and waits until communication is restored while recording the additional information-appended speech information 121. If communication with the server device 200 has been restored (step S105; Yes), the controller 110 ends the appearance thread (step S106).

Then, the controller 110 sends, via the communicator 25 to the server device 200, the additional information-appended speech information 121 recorded from the communication disconnection time stored in the storage 220 in step S102 to the current time (during communication disconnection) (step S107). Note that, in this case, the interaction apparatus 100 detects the restoration of communication, but a configuration is possible in which the server device 200 detects the restoration of communication and issues a request to the interaction apparatus 100 for the sending of the additional information-appended speech information 121. The server device 200 performs speech recognition on the additional information-appended speech information 121 sent by the interaction apparatus 100 in step S107, and the server device 200 sends the response sentence information to the interaction apparatus 100.

Then, the controller 110 as the response sentence information acquirer 113 acquires, via the communicator 25, the response sentence information sent by the server device 200 (step S108). Step S108 is also called a “response sentence information acquisition step.” In the present embodiment, a response sentence that is a complete sentence is acquired as the response sentence information, but the response sentence information is not limited thereto. For example, in a case in which the server device 200 is responsible for not all but a part of the response sentence creation, partial information may be acquired as the response sentence information (for example, information of a feature word, described later), and the response sentence may be completed in the interaction apparatus 100.

Then, the controller 110 as the responder 114 responds to the user on the basis of the response sentence information acquired by the response sentence information acquirer 113 (step S109). In the present embodiment, the response sentence information is the response sentence. Therefore, specifically, the responder 114 performs speech synthesis on the content of the response sentence and utters the response sentence from the speaker 23. Due to cooperation between the server device 200 and the interaction apparatus 100, the content of this response sentence corresponds to the speech during communication disconnection. As such, the user can confirm that the interaction apparatus 100 properly listened to the utterance content of the user during the communication disconnection as well. Step S109 is also called a “response step.” Then, the controller 110 returns to the processing of step S101.

Meanwhile, in step S101, if communication with the server device 200 is not disconnected (step S101; No), the controller 110 as the speech recorder 111 appends the speech acquired by the microphone 21 with information of the connection status (connected) and information of the current time, and records this data as the additional information-appended speech information 121 in the storage 120 (step S110). Then, the controller 110 sends, via the communicator 25 to the server device 200, the additional information-appended speech information 121 recorded in step S110 (during communication connection) (step S111).

Note that, in the case in which only the additional information-appended speech information 121 when the communication status is “disconnected” is set to be recorded in the storage 120, the processing of step S110 is skipped. Moreover, instead of the processing of step S111, the controller 110 appends the speech data acquired by the microphone 21 with the communication status (connected) and the current time, and sends this data, as the additional information-appended speech information 121, to the server device 200 via the communicator 25.

In the present embodiment, in either of the cases described above, speech recognition is performed on the speech data included in the additional information-appended speech information 121 sent at this point, and the server device 200 sends the response sentence to the interaction apparatus 100. The processing by the server device 200 (response sentence creation processing) is described later.

Then, the controller 110 as the response sentence information acquirer 113 acquires, via the communicator 25, the response sentence information sent by the server device 200 (step S112). Next, the controller 110 as the responder 114 responds to the user on the basis of the response sentence information acquired by the response sentence information acquirer 113 (step S113). In the present embodiment, the response sentence information is the response sentence. Therefore, specifically, the responder 114 performs speech synthesis on the content of the response sentence and utters the response sentence from the speaker 23. Due to the cooperation between the server device 200 and the interaction apparatus 100, the content of this response sentence corresponds to the speech during communication connection. As such, the response sentence has the same content as a response sentence created by conventional techniques. Then, the controller 110 returns to the processing of step S101.

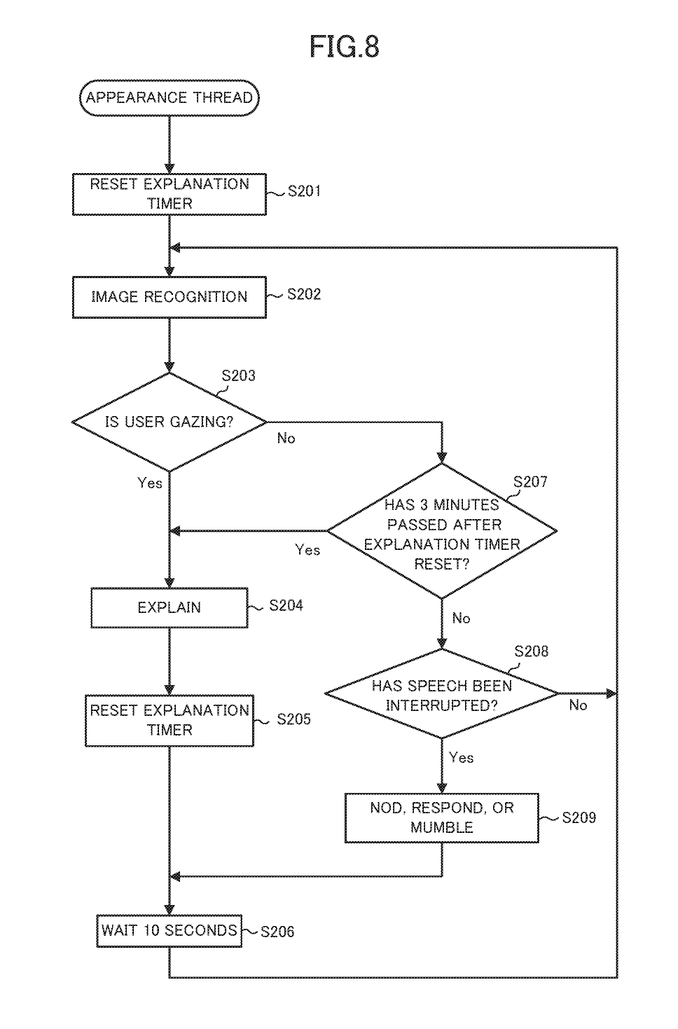

Next, the processing of the appearance thread started up in step S103 is described while referencing FIG. 8.

First, the controller 110 resets the timer of the controller 110 in order to use the timer to set an interval for giving an explanation (step S201). Hereinafter, this timer is called an “explanation timer.”

Then, the controller 110 recognizes an image acquired by the camera 22 (step S202), and determines whether the interaction apparatus 100 is being gazed at by the user (step S203). If the interaction apparatus 100 is being gazed at by the user (step S203; Yes), an explanation is given to the user such as, “I'm sorry, I don't have an answer for that” (step S204). This is because communication with the server device 200 at this time is disconnected and if is not possible to perform speech recognition and/or create a response sentence.

Then, having given the explanation, the controller 110 resets the explanation timer (step S205). Next, the controller 110 waits 10 seconds (step S206), and then returns to step S202. Here, the value of 10 seconds is an example of a wait time for ensuring that the interaction apparatus 100 does not repeat the same operation frequently. However, this value is not limited to 10 seconds and may be changed to any value, such as 3 seconds or 1 minute. Note that the wait time in step S206 is called an “appearance wait reference time” in order to distinguish this wait time from other wait times.

Meanwhile, in step S203, if the interaction apparatus 100 is not being gazed at (step S203, No), the controller 110 determines whether 3 minutes have passed since resetting of the value of the explanation timer (step S207). Here, the value of 3 minutes is an example of a wait time for ensuring that the interaction apparatus 100 does not frequently give explanations. However, this value is not limited to 3 minutes and may be changed to any value such as 1 minute or 10 minutes. Note that this wait time is called an “explanation reference time” in order to distinguish this wait time from other wait times.

If 3 minutes have passed (step S207; Yes), step S204 is executed. In this case, the subsequent processing is as described above. If 3 minutes have not passed (step S207; No), the controller 110 determines whether the speech acquired from the microphone 21 has been interrupted (step S208). The controller 110 determines that the speech has been interrupted in the case in which a silent period in the speech acquired from the microphone 21 continues for a reference silent time (for example, 1 minute) or longer.

If the speech is not interrupted (step S208; No), step S202 is executed. If the speech is interrupted (step S208; Yes), the controller 110 randomly selects one of three operations, namely “nod”, “respond”, and “mumble”, and controls the neck joint 31, the speaker 23, and the like to carry out the selected operation (step S209).

For example, in a case in which “nod” is selected, the controller 110 uses the neck joint 31 to move the head 20 so as to nod. Regarding the nod operation, the number of nods and speed at which the head 20 nods may be randomly changed by the controller 110 each time step S209 is executed. In a case in which “respond” is selected, the controller 110 uses the neck joint 31 to move the head 20 so as to nod and, as the same time, utters “Okay”, “I see”, “Sure”, or the like from the speaker 23. Regarding the respond operation, the number of times and speed at which the head 20 nods and the content uttered from the speaker 23 may be randomly changed by the controller 110 each time step S209 is executed.

In a case in which “mumble” is selected, the controller 110 causes a suitable mumble to be uttered from the speaker 23. Here, examples of the suitable mumble include a human mumble, a sound that imitates an animal sound, and an electronic sound indecipherable to humans that is typical in robots. Regarding the mumble operation, each time step S209 is executed, the controller 110 may randomly select a mumble from among multiple types of mumbles and cause this mumble to be uttered.

Then, step S206 is executed and the subsequent processing is as described above. As a result of the processing of the appearance thread described above, the interaction apparatus 100 can be made to appear as if listening to the user even when communication with the server device 200 is disconnected.

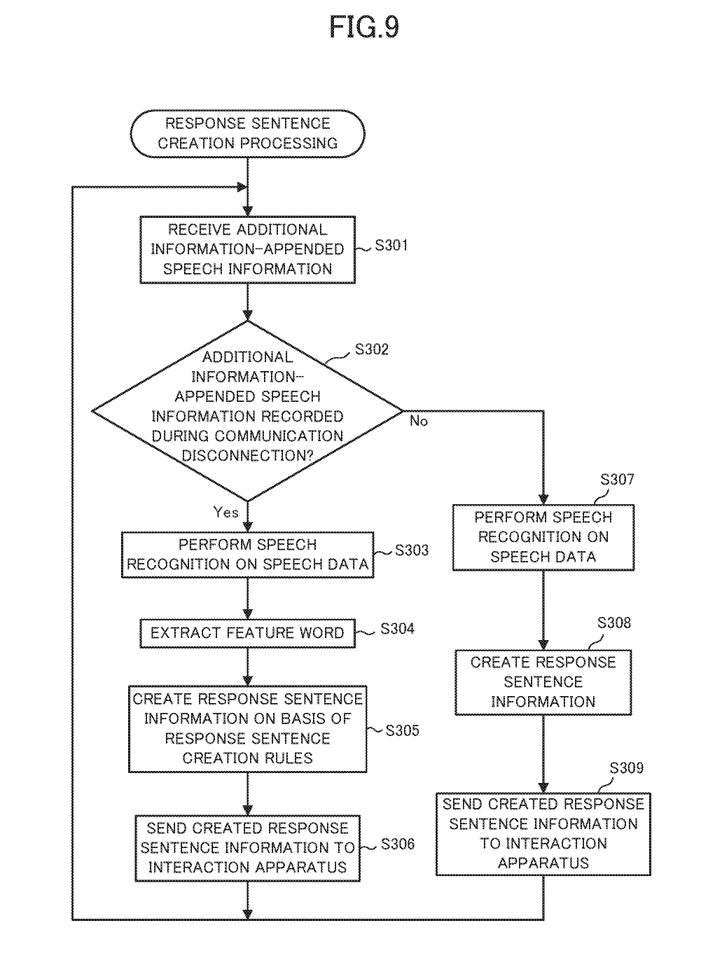

Next, the response sentence creation processing performed by the server device 200 is described while referencing FIG. 9. Note that the response sentence creation processing starts when the server device 200 is started up.

First, the communicator 230 of the server device 200 receives the additional information-appended speech information 121 sent by the interaction apparatus 100 (step S301). In a case in which the additional information-appended speech information 121 is not sent by the interaction apparatus 100, the server device 200 waits at step S301 until the additional information-appended speech information 121 is sent. Then, the controller 210 determines whether the received additional information-appended speech information 121 is information recorded during communication disconnection (step S302). As illustrated in FIG. 4, the additional information-appended speech information 121 includes information indicating the communication status and, as such, by referencing this information, it is possible to determine whether the received additional information-appended speech information 121 is information recorded during communication disconnection. Additionally, the server device 200 can ascertain the connection status with the interaction apparatus 100. Therefore, even if the additional information-appended speech information 121 does not include information indicating the communication status, it is possible to determine whether the additional information-appended speech information 121 is information recorded during communication disconnection on the basis of the information of the utterance date and time included in the additional information-appended speech information 121.

If the received additional information-appended speech information 121 is information recorded during communication disconnection (step S302; Yes), the controller 210 as the speech recognizer 211 performs speech recognition on the speech data included in the additional information-appended speech information 121 and generates text data (step S303). Then, the controller 210 as the feature word extractor 212 extracts a feature word from the generated text data (step S304). Next, the controller 210 as the response creator 213 creates response the sentence information (the response sentence in the present embodiment) on the basis of the extracted feature word and the response sentence creation rules 221 (step S305). Then, the response creator 213 sends the created response sentence (the response sentence information) to the interaction apparatus 100 via the communicator 230 (step S306). Thereafter, step S301 is executed.

Meanwhile, if the received additional information-appended speech information 121 is not information recorded during communication disconnection (step S302; No), the controller 210 as the speech recognizer 211 performs speech recognition on the speech data included in the additional information-appended speech information 121 and generates text data (step S307). Next, the controller 210 as the response creator 213 uses a conventional response sentence creation technique to create the response sentence information (the response sentence in the present embodiment) for the generated text data (step S308). Then, the response creator 213 sends the created response sentence (the response sentence information) to the interaction apparatus 100 via the communicator 230 (step S309). Thereafter, the server device 200 returns to step S301.

As a result of the response sentence creation processing described above, normal response sentence information is generated during communication connection, and the response sentence information is created on the basis of the feature word and the response sentence creation rules during communication disconnection. Accordingly, the server device 200 can create response sentence information that gives an impression that the interaction apparatus 100 properly listened to the utterance of the user U for speech information from when communication with the interaction apparatus 100 is disconnected.

Moreover, as a result of the interaction control processing of the interaction apparatus 100 described above, the response sentence information for the speech information from when communication with the server device 200 is disconnected can be acquired from the server device 200. As such, it is possible for the interaction apparatus 100 to utter a response sentence that gives an impression that the interaction apparatus 100 properly listened to the utterance of the user U.

For example, the interaction apparatus 100 cannot respond with response sentences at the times when the user utters the utterance contents of No. 1 to No. 3 in FIG. 4. However, the utterance contents of the user U depicted in No. 1 to No. 3 are sent to the server device 200 at the point in time at which communication with the server device 200 is restored. Then, the feature word extractor 212 of the server device 200 extracts, from the utterance content of the user, “hot” as the feature word that is used the most. By applying “hot” to the response sentence creation rules illustrated in FIG. 6, the response creator 213 creates the response sentence information (the response sentence in the present embodiment), “Saying hot, hot will only make it hotter.” Then, the response sentence information acquirer 113 of the interaction apparatus 100 acquires the response sentence (the response sentence information), and the responder 114 can cause the interaction apparatus 100 to utter “Saying hot, hot will only make it hotter” to the user.

Thus, the interaction apparatus 100 cannot make small responses when communication with the server device 200 is disconnected. However, when communication is restored, by uttering a response sentence based on the feature word (a specific word that is used the most, or the like) included in the utterance content of the user U during the disconnection, the interaction apparatus 100 can indicate, with a comparatively short response sentence, to the user U that the interaction apparatus 100 has been properly listening to the utterance content of the user U during the communication disconnection as well. As such, the interaction apparatus 100 can improve answering technology for cases in which the communication situation is poor.

### Embodiment 2

In Embodiment 1, the interaction apparatus 100 responds with a response sentence corresponding to a specific word (one feature word) that is used the most, or the like, in the entire content of the utterance of the user U while communication with the server device 200 is disconnected. Since the feature word is more likely to leave an impression on the user U, it is thought that few problems will occur with such a response. However, in some cases, the user U may change topics during the utterance and, over time, a plurality of feature words may be used at approximately the same frequency. In such a case, it may be preferable to extract the feature word that is used the most for each topic and respond a plurality of times with response sentences that correspond to each of the plurality of extracted feature words. As such, in Embodiment 2, an example is described in which it is possible to respond with a plurality of response sentences.

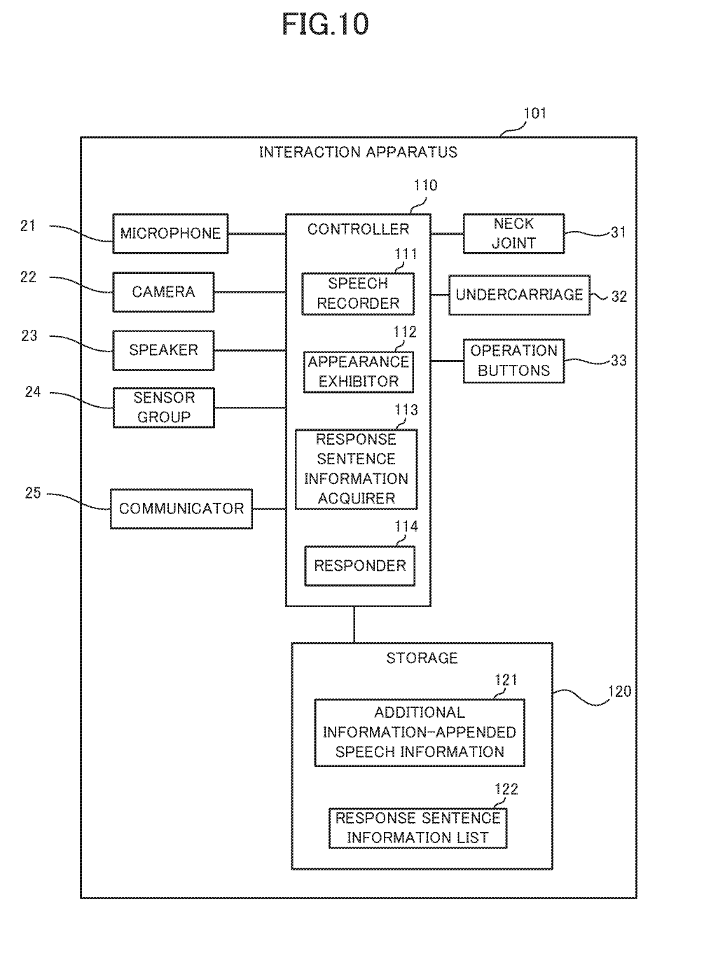

An interaction system 1001 according to Embodiment 2 is the same as the interaction system 1000 according to Embodiment 1 in that the interaction system 1001 according to Embodiment 2 includes an interaction apparatus 101 and a server device 201. The interaction apparatus 101 according to Embodiment 2 has the same appearance as the interaction apparatus 100 according to Embodiment 1. As illustrated in FIG. 10, the functional configuration of the interaction apparatus 101 differs from that of the interaction apparatus 100 according to Embodiment 1 in that, with the interaction apparatus 101, a response sentence information list 122 is stored in the storage 120. The functional configuration of the server device 201 is the same as that of the server device 200 according to Embodiment 1.

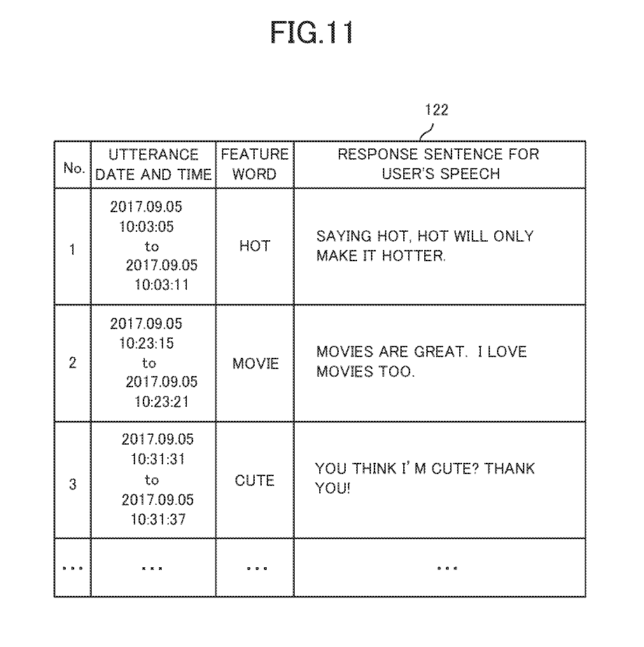

As illustrated in FIG. 11, the response sentence information list 122 includes an “utterance date and time”, a “feature word”, and a “response sentence for user speech”, and these items are information that is sent from the server device 201. For example, No. 1 in FIG. 11 indicates that the feature word included in the content that the user U uttered from 2017/9/5 10:03:05 to 2017/9/5 10:03:11 is “hot”, and that the response sentence for this user utterance is “Saying hot, hot will only make it hotter.” The same applies for No. 2 and so forth. Note that, while only examples for the sake of description, the “utterance content of the user” to which the “response sentence for user speech” illustrated in FIG. 11 corresponds is the additional information-appended speech information 121 illustrated in FIG. 4.

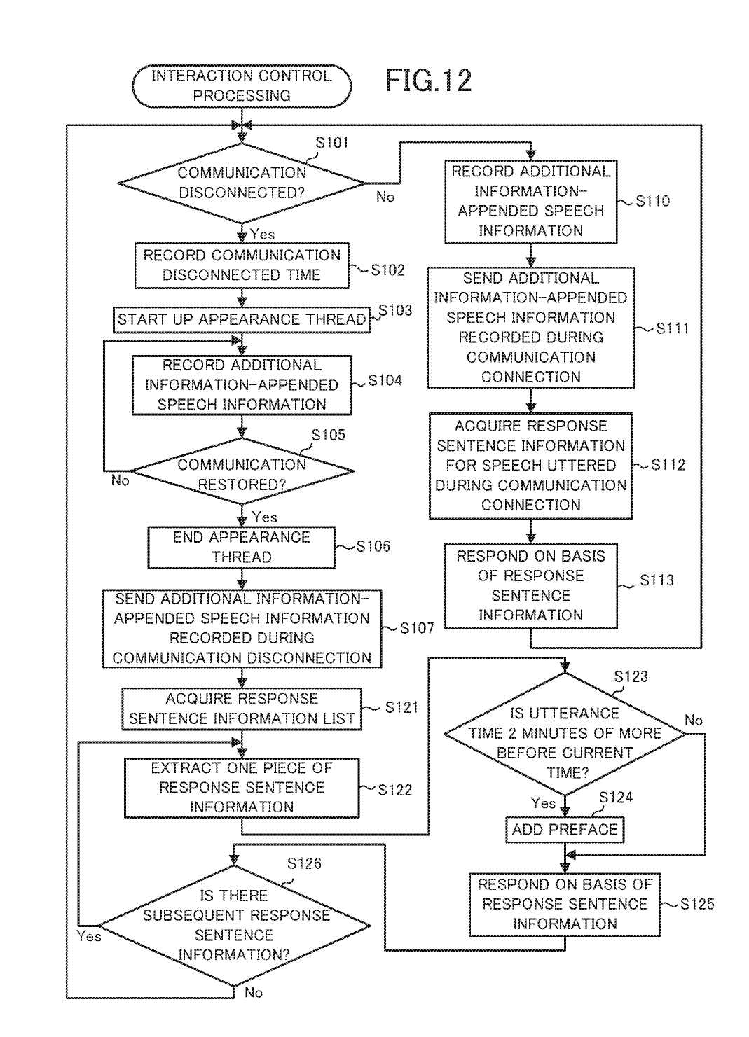

Next, the interaction control processing performed by the controller 110 of the interaction apparatus 101 is described while referencing FIG. 12. This processing partially differs from the interaction control processing (FIG. 7) of the interaction apparatus 100 according to Embodiment 1 and, as such, description will center on the differences.

Steps S101 to S107 and steps S110 to S113 are the same as in the processing that is described while referencing FIG. 7. In step S121, which is the step after step S107, the controller 110 as the response sentence information acquirer 113 acquires, via the communicator 25, the response sentence information list 122 sent by the server device 201. Next, since one or more pieces of response sentence information is included in the response sentence information list 122, the controller 110 as the response sentence information acquirer 113 extracts one piece of response sentence information from the response sentence information list 122 (step S122).

The response sentence information extracted from the response sentence information list 122 includes an utterance date and time, as illustrated in FIG. 11. The controller 110 determines whether the end time of the utterance date and time is 2 minutes or more before the current time (step S123). Here, the 2 minutes is the time for determining whether to add a preface at step S124, described next. As such, the 2 minutes is also called a “preface determination reference time,” and is not limited to 2 minutes. The preface determination reference time may be changed to any value such as, for example, 3 minutes or 10 minutes,

If the end time of the utterance date and time is 2 minutes or more before the current time (step S123; Yes), the controller 110 as the responder 114 adds a preface to the response sentence information (step S124). Here, the preface is a phrase such as, for example, “By the way, you mentioned that it was hot . . . ”. More generally, the preface can be expressed as, “By the way, you mentioned [Feature word] . . . ”. By adding the preface, situations can be avoided in which the user U is given the impression that a response sentence corresponding to the feature word is being suddenly uttered. Additionally, if the end time of the utterance date and time is not 2 minutes or more before the current time (step S123; No), step S125 is executed without adding the preface.

Then, the controller 110 as the responder 114 responds to the user U on the basis of the response sentence information (when the preface has been added in step S124, the response sentence information with the preface) acquired by the response sentence information acquirer 113 (step S125). In the present embodiment, the response sentence information is the response sentence. Therefore, specifically, the responder 114 performs speech synthesis on the content of the response sentence (or the response sentence with the preface) and utters the response sentence from the speaker 23. Then, the controller 110 determines if there is subsequent response sentence information (response sentence information that has not been the subject of utterance) in the response sentence information list 122 (step S126).

If there is subsequent response sentence information (step S126; Yes), the controller 110 returns to step S122, and the processing of steps S122 to S125 is repeated until all of the response sentence information in the response sentence information list has been uttered. If there is no subsequent response sentence information, (step S126; No), step S101 is executed. The response sentence information list includes the plurality of response sentences that are created by the server device 201 and are of content that corresponds to the speech during communication disconnection. As such, the user U can confirm that the interaction apparatus 101 properly listened to the utterance content of the user U during the communication disconnection as well.

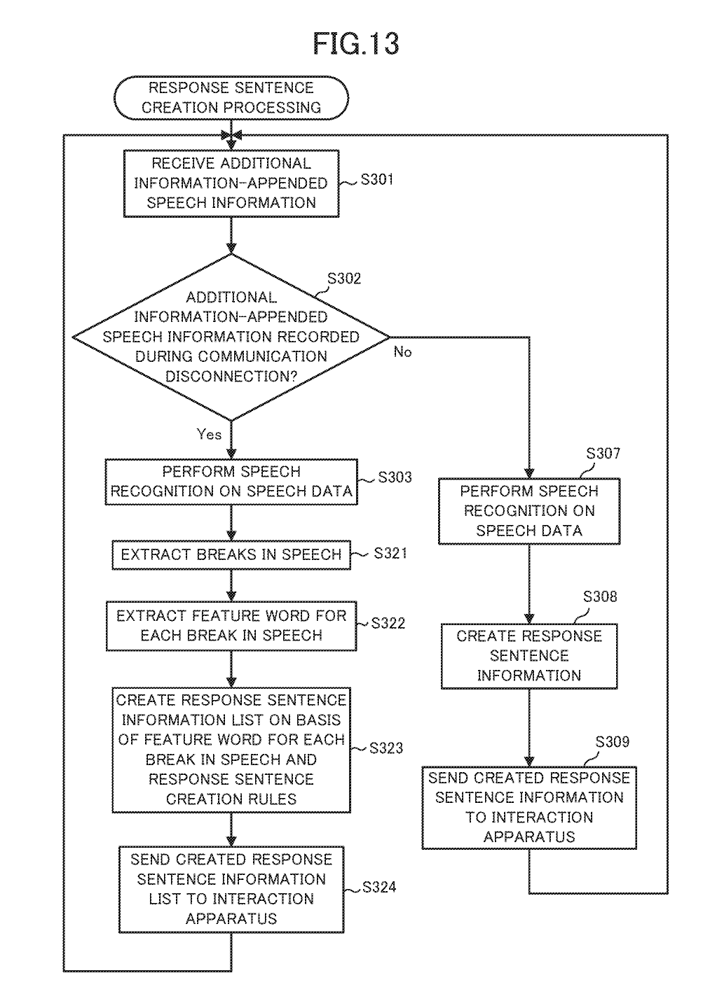

Next, the response sentence creation processing performed by the server device 201 is described while referencing FIG. 13. This processing partially differs from the response sentence creation processing (FIG. 9) of the interaction apparatus 200 according to Embodiment 1 and, as such, description will center on the differences.

Steps S301 to S303 and steps S307 to S309 are the same as in the processing that is described while referencing FIG. 9. In step S321, which is the step after step S303, the controller 210 extracts breaks in speech (topics) from the speech information (the speech data in the present embodiment) sent by the interaction apparatus 101. The breaks in speech (topics) may be extracted on the basis of the text data that are generated in step S303 or, alternatively, the breaks in speech (topics) may be extracted on the basis of the speech data, that is, on the basis of breaks in the speech, for example.

Then, the controller 210 as the feature word extractor 212 extracts a feature word for each of the breaks in speech (topics) extracted in step S321 (step S322). For example, a case is considered in which breaks in speech of the speech data are extracted at the 3 minute position and the 5 minute position from the start of the utterance. In this case, a specific word that is included the most in the portion from the start of the utterance until 3 minutes after the start is extracted as the feature word of a first topic. Moreover, a specific word that is included the most in the portion from 3 minutes after the start of the utterance until 5 minutes after the start is extracted as the feature word of a second topic. Additionally, a specific word that is included the most in the portion from 5 minutes after the start of the utterance is extracted as the feature word of a third topic.

Then, the controller 210 as the response creator 213 applies the feature word extracted for each of the breaks in speech (topics) to the response sentence creation rules 221 to create the response sentence information (the response sentences in the present embodiment), appends the response sentences with utterance date and times and feature words, and creates a response sentence information list such as that illustrated in FIG. 11 (step S323). Then, the response creator 213 sends the created response sentence information list to the interaction apparatus 101 via the communicator 230 (step S324). Thereafter, step S301 is executed.

As a result of the response sentence creation processing described above, the response sentence information list is created on the basis of the feature word included in each of the topics, even when the user U makes an utterance including a plurality of topics during communication disconnection. Accordingly, the server device 201 can create response sentence information corresponding to each of the plurality of topics uttered while communication with the interaction apparatus 101 is disconnected.

Moreover, as a result of the interaction control processing of the interaction apparatus 101 described above, the response sentence information list for the speech information from when communication with the server device 201 is disconnected is acquired from the server device 201. As such, it is possible for the interaction apparatus 101 to respond using a plurality of response sentences. As a result, compared to a response using a single response sentence, it is possible to perform a response that gives a greater impression that the interaction apparatus 101 listened to the utterance of the user U.

For example, the interaction apparatus 101 cannot respond with a response sentence at the time when the user U utters the utterance content of No. 8 to No. 12 in FIG. 4. However, the utterance contents of the user indicated in No. 8 to No. 12 are sent to the server device 201 at the point in time at which connection with the server device 201 is restored. Then, as a result of the response sentence creation processing of the server device 201, a response sentence information list indicating No. 2 and No. 3 of FIG. 11 is created from these utterance contents of the user U. Then, the response sentence information acquirer 113 of the interaction apparatus 101 acquires the response sentence information list, and the responder 114 can cause the interaction apparatus 101 to utter, to the user, “By the way, you mentioned movies. Movies are great. I love movies too.”, “By the way, you mentioned cute. You think I'm cute? Thank you!”, or the like.

Thus, the interaction apparatus 101 cannot make small responses when communication with the server device 201 is disconnected. However, when communication is restored, the interaction apparatus 101 can utter response sentences based on feature words (specific words that are used the most, or the like) included in each of the topics, even in cases in which the utterance content of the user U during disconnection includes a plurality of topics. Accordingly, the interaction apparatus 101 can express that the interaction apparatus 101 has properly listened to the utterance content of the user for each topic. As such, the interaction apparatus 101 can further improve answering technology for cases in which the communication situation is poor.

### Embodiment 3

Configuring the interaction apparatus such that the position of the interaction apparatus can be acquired makes it possible to include information related to the position in the response sentence. With such a configuration, it is possible to indicate where the interaction apparatus heard the utterance content of the user U. Next, Embodiment 3, which is an example of such a case, will be described.

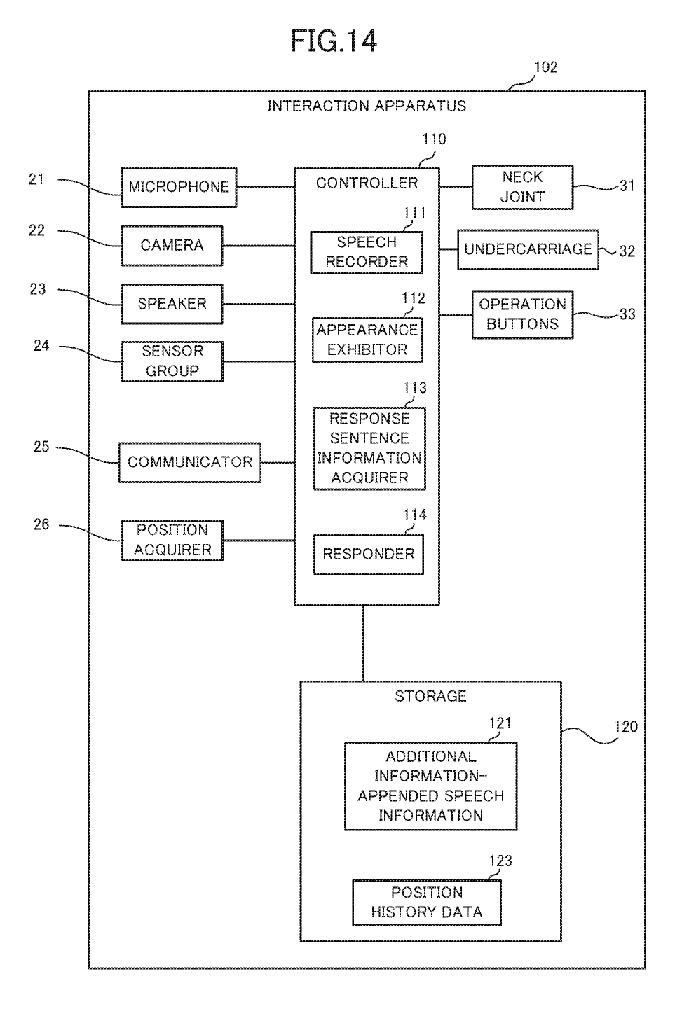

An interaction system 1002 according to Embodiment 3 is the same as the interaction system 1000 according to Embodiment 1 in that the interaction system 1001 according to Embodiment 3 includes an interaction apparatus 102 and a server device 202. The interaction apparatus 102 according to Embodiment 3 has the same appearance as the interaction apparatus 100 according to Embodiment 1. As illustrated in FIG. 14, the functional configuration of the interaction apparatus 102 differs from that of the interaction apparatus 100 according to Embodiment 1 in that the interaction apparatus 102 includes a position acquirer 26, and position history data 123 is stored in the storage 120. The functional configuration of the server device 202 is the same as that of the server device 200 according to Embodiment 1.

The position acquirer 26 can acquire coordinates (positional data) of a self-position (the position of the interaction apparatus 102) by receiving radio waves from global position system (GPS) satellites. The information of the coordinates of the self-position is expressed in terms of latitude and longitude.

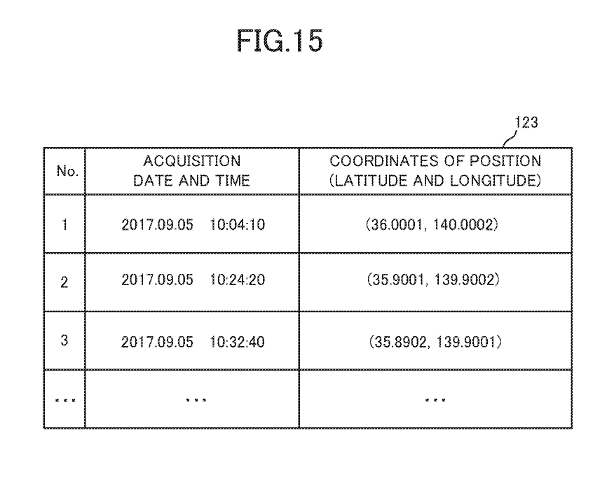

As illustrated in FIG. 15, the position history data 123 includes a history of two kinds of information that are an acquisition date and time indicating when the self-position is acquired and coordinates (latitude and longitude) of the self-position.

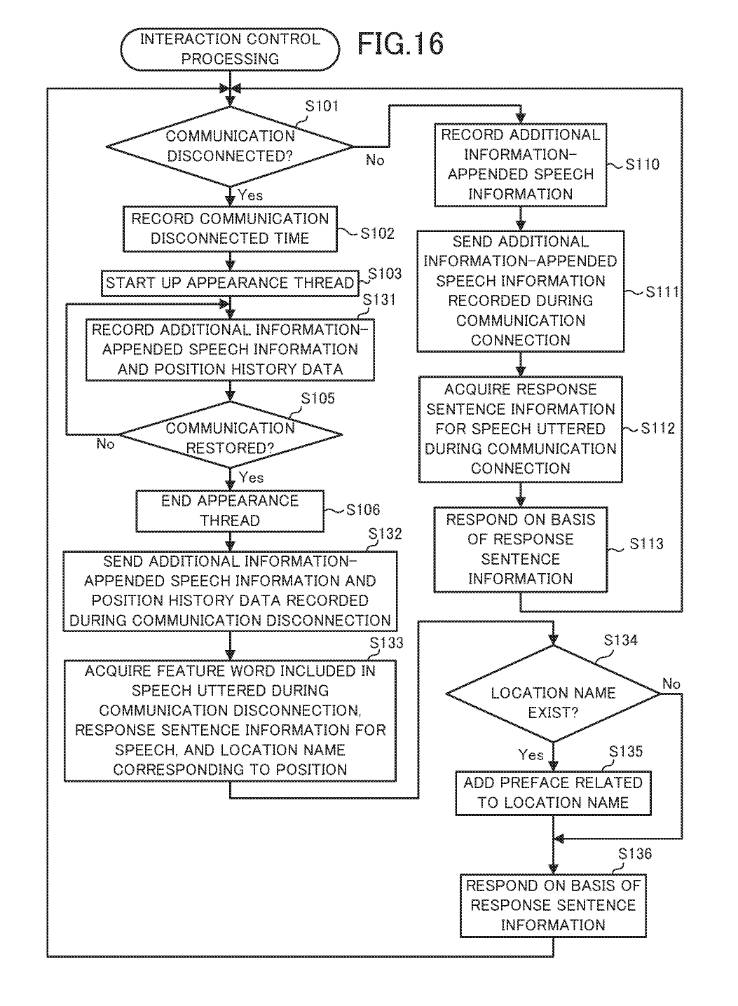

Next, the interaction control processing performed by the controller 110 of the interaction apparatus 102 is described while referencing FIG. 16. This processing partially differs from the interaction control processing (FIG. 7) of the interaction apparatus 100 according to Embodiment 1 and, as such, description will center on the differences.

Steps S101 to S103, steps S105 to S106, and steps S110 to S113 are the same as in the processing described while referencing FIG. 7. In step S131, which is the step after step S103, the controller 110 as the speech recorder 111 records, in the storage 120, the speech data acquired by the microphone 21 together with the communication status (disconnected) and the current time as the additional information-appended speech information 121. Additionally, the controller 110 stores, in the storage 120, the positional data acquired by the position acquirer 26 together with an acquisition date and time as the position history data 123.

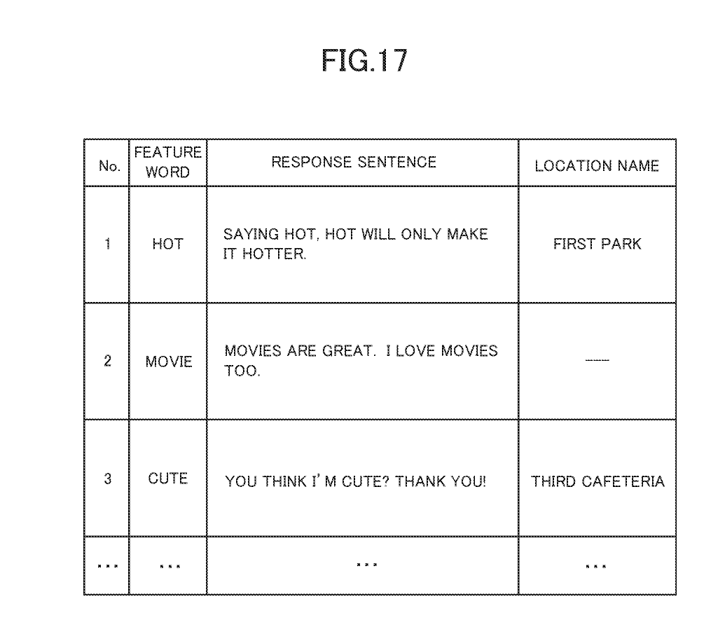

Then, in step S132, which is the step after step S106, the controller 110 sends, via the communicator 25 to the server device 202, the additional information-appended speech information 121 and the position history data 123 recorded from the communication disconnection time stored in the storage 220 in step S102 to the current time (during communication disconnection). Here, the server device 202 performs speech recognition and location name searching on the sent additional information-appended speech information 121 and the sent position history data 123, and the server device 202 sends, to the interaction apparatus 102, the feature word, the response sentence, and the location name corresponding to the position. In a specific example, if there is a location name that corresponds to the position, as illustrated in No. 1 of FIG. 17, the server device 202 sends the feature word “hot”, the response sentence, and the location name “First Park.” Alternatively, if there is not a location name that corresponds to the position, as illustrated in No. 2 of FIG. 17, the server device 202 sends the feature word “movie”, the response sentence, and “- - -” data indicating that there is no location name. The processing by the server device 202 (response sentence creation processing) is described later.

Then, the controller 110 as the response sentence information acquirer 113 acquires, via the communicator 25, the feature word, the response sentence information (the response sentence in the present embodiment), and the location name related to the position sent by the server device 202 (step S133). Then, the controller 110 as the responder 114 determines whether there is a location name that corresponds to the position (step S134). If there is a location name that corresponds to the position (step S134; Yes), the response sentence information acquirer 113 adds a preface related to the location to the acquired response sentence information (step S135). Here, the preface related to the location is a phrase such as, for example, “By the way, you mentioned that it was hot when you were at the park . . . ”. More generally, the preface related to the location can be expressed as, “By the way, you mentioned [Feature word] when you were at [location name that corresponds to the position] . . . ”. Additionally, if there is not a location name that corresponds to the position (step S134; No), step S136 is executed without adding the preface.

Then, the controller 110 as the responder 114 responds to the user U on the basis of the response sentence information (the response sentence information with the preface when the preface has been added in step S135) acquired by the response sentence information acquirer 113 (step S136). In the present embodiment, the response sentence information is the response sentence. Therefore, specifically, the responder 114 performs speech synthesis on the content of the response sentence (or the response sentence with the preface) and utters the response sentence from the speaker 23. Then, the controller 110 returns to the processing of step S101.

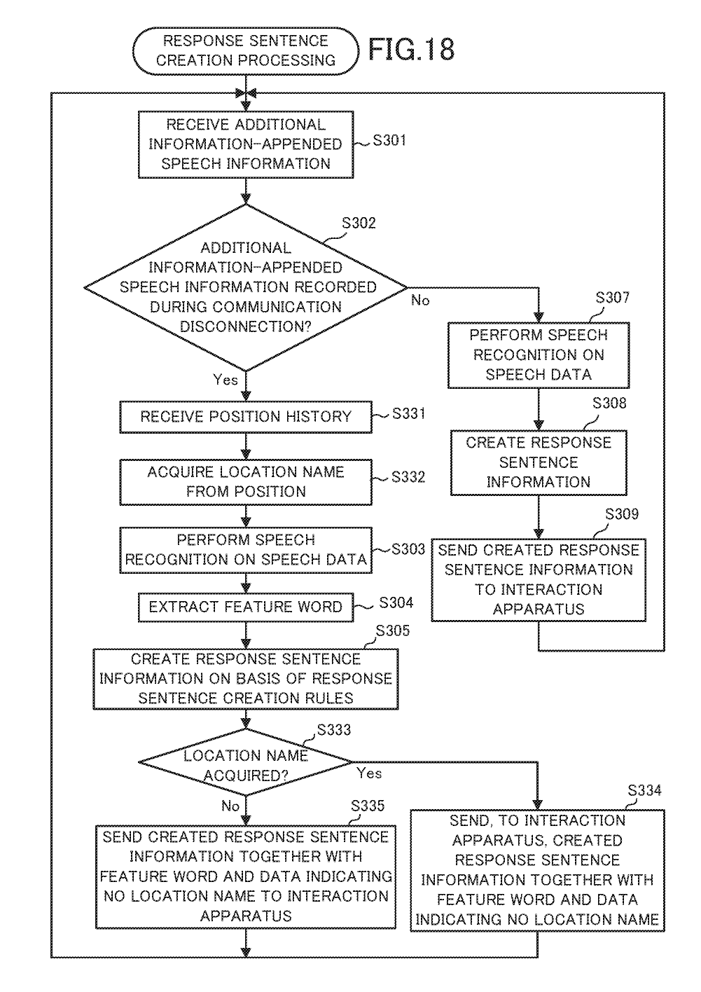

Next, the response sentence creation processing performed by the server device 202 is described while referencing FIG. 18. This processing partially differs from the response sentence creation processing of the interaction apparatus 200 according to Embodiment 1 (FIG. 9) and, as such, description will center on the differences.

Steps S301 to S302, steps S303 to S305, and steps S307 to S309 are the same as in the processing described while referencing FIG. 9. In step S331, which is the processing when the determination of step S302 is Yes, the communicator 230 receives the position history data 123 sent by the interaction apparatus 102. Then, the controller 210 acquires the location name for each of the coordinates included in the position history data 123 by using a cloud service for acquiring location names from latitude and longitude (step S332). For example, building names and other highly specific location names can be acquired by receiving information from companies that own map databases such as Google (registered trademark) and Zenrin (registered trademark). Note that there are cases in which location names cannot be acquired because there are coordinates for which location names are not defined.

Then, in step S333, which is the step after step S305, the controller 210 determines whether the acquisition of the location name in step S332 has succeeded or failed. If the acquisition of the location name has succeeded (step S333; Yes), the response creator 213 sends, via the communicator 230 to the interaction apparatus 102, the feature word extracted in step S304, the response sentence information created in step S305, and the location name acquired in step S332 (step S334). This sending data is, for example, data such as that illustrated in No. 1 and No. 3 of FIG. 17.

If the acquisition of the location name has failed (step S333; No), the response creator 213 sends, via the communicator 230 to the interaction apparatus 102, the feature word extracted in step S304, the response sentence information created in step S305, and data indicating that there is no location (step S335). This sending data is, for example, data such as that illustrated in No. 2 of FIG. 17.

Thereafter, in either case (when the acquisition of the location name has succeeded or failed), step S301 is executed.

As a result of the response sentence creation processing described above, the response sentence information for the utterance content during communication disconnection can be appended with information of the feature word and information of the location name and sent to the interaction apparatus 102. Moreover, as a result of the interaction control processing of the interaction apparatus 102 described above, response sentence information for the speech information from when communication with the server device 202 is disconnected is acquired from the server device 202. As such, it is possible for the interaction apparatus 102 to utter a response sentence that gives an impression that the interaction apparatus 102 properly listened to what the user U uttered and where the user U uttered the utterance. As such, the interaction apparatus 102 can further improve answering technology for cases in which the communication situation is poor.

### Modified Examples

The embodiments described above can be combined as desired. For example, Embodiment 2 and Embodiment 3 can be combined to cause the interaction apparatus to utter response sentences corresponding to a plurality of topics together with prefaces for the location where each of the topics is uttered. As a result, the interaction apparatus can be caused to utter an utterance such as, for example, “By the way, you mentioned that it was hot when you were at the First Park. Saying hot, hot will only make it hotter.”, “By the way, you mentioned movies. Movies are great. I love movies.” and “By the way, you mentioned cute when you were at the Third Cafeteria. You think I'm cute? Thank you!”. As a result, the interaction apparatus can give answers that correspond to topic changes in the utterance content of the user and to the location where the various topics are uttered when in a state in which the interaction apparatus cannot communicate with the server device. Moreover, with such a configuration, it is possible to answer as if the interaction apparatus is listening properly. Accordingly, the modified examples of the interaction apparatus can further improve answering technology for cases in which the communication situation is poor.

In the embodiments described above, examples are described in which disruptions are assumed in the communication environment between the server device and the interaction apparatus. However, the technology according to the present application can also be applied to a case in which communication between the devices is intentionally cut off to conserve power or the like.

In the embodiments described above, examples are described that assumed that the interaction apparatus is responding to a single user. However, providing the interaction apparatus with an individual recognition function will enable the interaction apparatus to give individual answers to a plurality of users.

Note that, the various functions of the interaction apparatuses 100, 101, and 102 can be implements by a computer such as a typical personal computer (PC). Specifically, in the embodiments described above, examples are described in which the programs, such as the interaction control processing, performed by the interaction apparatuses 100, 101, and 102 are stored in the advance in the ROM of the storage 120. However, a computer may be configured that is capable of realizing these various features by storing and distributing the programs on a non-transitory computer-readable recording medium such as a compact disc read-only memory (CD-ROM), a digital versatile disc (DVD), and a magneto-optical disc (MO), reading out and installing these programs on the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### Advantageous Effects of the Embodiments

(1) Since the response sentences after communication restoration are created on the basis of the predetermined response sentence creation rules, and fundamentally on the basis of the feature words, there is little awkwardness and the answering feels natural to the user.

(2) Due to the response sentence creation rules, response sentences can be generated that feel natural to the user.

(3) Even when communication is disconnected for an extended period of time, feature words are extracted for each topic and, as such, appropriate response sentences can be generated for each topic. Additionally, response sentences with prefaces can be generated to remind the user of the corresponding feature words.

(4) Even when communication is disconnected for an extended period of time, content of when and where the user spoke can be sent to the server. As such, response sentences with prefaces including location information can be generated.

What is claimed is:

1. An interaction apparatus, comprising:
a memory;
a communicator; and
a controller configured to
record, in the memory, speech information that is based on speech uttered by a user;
communicate with an external server device via the communicator;
in a state in which communication with the server device is restored after temporal communication disconnection, send the speech information recorded during the communication disconnection to the server device, and acquire, from the server device, response sentence information for the speech information; and
respond to the user with a response sentence created on the basis of the acquired response sentence information, wherein the response sentence is related to the speech information recorded during the communication disconnection;
wherein the response sentence information is created on the basis of response rules.

2. The interaction apparatus according to claim 1, wherein the response sentence information is created on the basis of a feature word included in text data obtained from the speech information.

3. The interaction apparatus according to claim 1, wherein the response sentence for responding to the user in the state in which communication with the server device is restored after the temporal communication disconnection is different from a response sentence for responding to the user while the communication with the server device continues without communication disconnection.

4. The interaction apparatus according to claim 1, wherein the controller is configured to perform control to exhibit behavior that appears to the user as if the interaction apparatus is listening to the user, while the communication with the server device is disconnected.

5. The interaction apparatus according to claim 4, wherein the controller is configured to perform control to execute at least one of nodding, responding, and mumbling in accordance with the acquired speech data.

6. The interaction apparatus according to claim 4, wherein the controller is configured to, upon elapse of an explanation reference time, perform control to explain to the user a failure to make an appropriate response.

7. The interaction apparatus according to claim 1, wherein the controller is configured to
acquire, via a microphone, the speech uttered by the user as the speech data, and
respond, via a speaker, to the user with the response sentence.

8. The interaction apparatus according to claim 1, wherein the feature word is a specific word included most in the text data that are acquired by performing the speech recognition on the speech data.

9. The interaction apparatus according to claim 1, wherein the feature word is a specific word modified by an emphasis modifier among specific words included in the text data that are acquired by performing the speech recognition on the speech data.

10. The interaction apparatus according to claim 1, wherein the response sentence information is created by applying a response sentence creation rule to the feature word.

11. The interaction apparatus according to claim 1, wherein the controller is configured to
acquire, from the server device, response sentence information for the speech information for each topic of the speech information recorded during the communication disconnection, and
respond to the user with a response sentence created on the basis of the acquired response sentence information for each topic.

12. The interaction apparatus according to claim 1, wherein the controller responds to the user with a response sentence obtained by adding a preface to the response sentence created on the basis of the acquired response sentence information.

13. The interaction apparatus according to claim 1, further comprising:
a position acquirer configured to acquire positional data of the interaction apparatus, wherein
the controller is configured to
in a state in which the communication with the server device is restored after temporal communication disconnection, send, to the server device, the speech information recorded during the communication disconnection and the positional data acquired during the communication disconnection, and acquire, from the server device, the response sentence information for the speech information and a location name corresponding to the positional data, and
respond to the user with a response sentence obtained by adding a preface including the acquired location name to the response sentence created on the basis of the acquired response sentence information.

14. An interaction method, comprising:
recording speech information that is based on speech uttered by a user;
in a state in which communication with an external server device is restored after temporal communication disconnection, causing the server device to create response sentence information corresponding to the speech information recorded during the communication disconnection; and
responding to the user with a response sentence created on the basis of the response sentence information that is received from the server device,
wherein the response sentence information is created on the basis of response rules.

15. A server device in an interaction system, the interaction system including the server device and an interaction apparatus configured to create a response sentence for speech uttered by a user through communication with the server device, the server device being a device external to the interaction apparatus, the server device comprising:
a communicator configured to communicate with the interaction apparatus;
a receiver configured to receive, from the interaction apparatus via the communicator, speech information that is based on the speech uttered by the user;
a speech recognizer configured to generate text data by performing speech recognition on the speech information received by the receiver;
a feature word extractor configured to extract, from the text data generated by the speech recognizer, a feature word that is a characteristic word included in the text data;
a response creator configured to create response sentence information on the basis of the feature word extracted by the feature word extractor; and
a transmitter configured to send, via the communicator, the response sentence information created by the response creator; wherein
in a state in which communication with the interaction device via the communicator is restored after temporal communication disconnection, the server device receives, from the interaction apparatus, speech information that is information during the communication disconnection, creates response sentence information for the received speech information, and sends the created response sentence information to the interaction apparatus.
